(19) United States
(12) Patent Application Publication
(10) Pub. No.: US 2025/0383983 A1
(43) Pub. Date: Dec. 18, 2025

(54) METHOD AND DEVICE FOR INCREASING LOGICAL-TO-PHYSICAL TABLE CAPACITY IN DATA STORAGE MANAGEMENT

(71) Applicant: Samsung Electronics Co., Ltd., Gyeonggi-do (KR)

(72) Inventors: Chun-Chu Chen-Jhy Archie WU, San Carlos, CA (US); Mark Allen GAERTNER, Fort Myers, FL (US); James David SAWIN, Sterling, MA (US)

(21) Appl. No.: 19/194,940

(22) Filed: Apr. 30, 2025

Related U.S. Application Data
(60) Provisional application No. 63/660,139, filed on Jun. 14, 2024.

(51) Int. Cl. G06F 12/02; G06F 12/0891; G06F 13/16

(52) U.S. Cl. CPC G06F 12/0246; G06F 12/0891; G06F 13/1642; G06F 2212/7201

(57) ABSTRACT

Methods and devices are provided in which a controller of a storage device receives a command with a corresponding logical page number (LPN). The LPN is mapped to a physical page number (PPN) in a storage medium of the storage device based on a logical-to-physical (L2P) look-up table (LUT) including most significant bits (MSBs) of a PPN entry. Least significant bits (LSBs) of the PPN entry are generated from the LPN based on a hash function. The PPN for the command is determined based on the MSBs, the LSBs, and meta area in the storage medium.

### PRIORITY

This application is based on and claims priority under 35 U.S.C. § 119(e) to U.S. Provisional Patent Application Ser. No. 63/660,139, filed on Jun. 14, 2024, the entire contents of which are incorporated herein by reference.

### TECHNICAL AREA

The present disclosure relates generally to data storage management systems, and more particularly, to a method for increasing logical-to-physical (L2P) table capacity in a data storage management system.

### BACKGROUND

The present background section is intended to provide context only, and the disclosure of any concept in this section does not constitute an admission that said concept is prior art.

Complexities in data storage management continue to grow with increasing computational demand. The computational demand may be demonstrated through an increase in commands (e.g., read commands, write commands, or copy commands), issued by a host and inserted into a data storage management system for execution. A logical address (e.g., logical page number (LPN)) may be mapped to a physical address (e.g., physical page number (PPN)) at a one-to-one ratio via a logical-to-physical (L2P) look-up table (LUT). As drive size increases, the L2P LUT upscales in a non-linear manner. A need exists for a method to process commands in a drive with increased size and a linearly upscaled L2P LUT.

### SUMMARY

According to an embodiment, a controller of a storage device receives a command with a corresponding LPN. The controller maps the LPN to a PPN in a storage medium of the storage device based on an L2P LUT including most significant bits (MSBs) of a PPN entry. The controller generates least significant bits (LSBs) of the PPN entry from the LPN based on a hash function. The controller determines the PPN for the command based on the MSBs, the LSBs, and a meta area in the storage medium.

According to this embodiment, the command may be a read command and determining the PPN may include obtaining data entries from the storage medium based on the MSBs of the L2P LUT, performing a conflict check on the data entries based on a centralized mapping table in the meta area of the storage medium, and outputting a data entry from the data entries that passes the conflict check. Alternatively, determining the PPN may include obtaining a first read from the storage medium based on the MSBs of the L2P LUT and the LSBs from the hash function, where the first read includes a first data entry and a first meta area, and performing a first conflict check on the first read based on a first mapping table of the first meta area. Performing the first conflict check may include comparing the LPN of the read command to an LPN of the first meta area.

According to this embodiment, the LPN of the read command may be the same as the LPN of the first meta area, and the first data entry may be output from the storage medium.

According to this embodiment, the LPN of the read command may be different from the LPN of the first meta area, and determining the PPN may include obtaining a second read from the storage medium based on the first mapping table, where the second read includes a second data entry, and outputting the second data entry from the storage medium. Alternatively, determining the PPN may include obtaining a subsequent read from the storage medium, where the subsequent read includes a subsequent data entry and a subsequent meta area, performing a next conflict check on the subsequent read based on a subsequent mapping table of the subsequent meta area, repeating the obtaining and performing steps in case that the next conflict check fails, and outputting the subsequent data entry from the storage medium in case that the next conflict check passes.

According to this embodiment, the command may be a write command. The generated LSBs may be received at a hash queue as an LSB entry. A plurality of LSB entries may be output from the hash queue at one time. Meta data may be generated based on the plurality of LSB entries. The meta data may be combined with corresponding data entries to generate write data. The write data may be stored at the PPN based on the MSBs and the LSBs.

According to this embodiment, the hash queue may include random queues that each output one of the plurality of LSB entries. A head-of-line (HOL) of one or more of the random queues may have a valid entry, and entries from the HOL of the random queues may be released. Alternatively, an HOL of one or more of the random queues may have an invalid entry, the hash queue may have fewer entries than capacity, and next generated LSBs may be received at the hash queue as a next LSB entry before outputting the plurality of LSB entries. Alternatively, an HOL of one of the random queues may have an invalid entry, the hash queue may be full, valid entries may be released, an entry from HOL of a longest queue may be selected to release from the one of the random queues having the invalid entry, and the selected entry may be released with the valid entries.

According to an embodiment, a storage device is provided that includes a controller and a non-transitory computer readable storage medium storing instructions. When executed, the instructions cause the processor to receive a command with a corresponding LPN. The LPN is mapped to a PPN in the storage medium based on an L2P LUT including MSBs of a PPN entry. LSBs of the PPN entry are generated from the LPN based on a hash function. The PPN for the command is determined based on the MSBs, the LSBs, and a meta area in the storage medium.

According to this embodiment, the command may be a read command, data entries may be obtained from the storage medium based on the MSBs of the L2P LUT, a conflict check may be performed on the data entries based on a centralized mapping table in a meta area of the storage medium, and a data entry may be output from the data entries that passes the conflict check. Alternatively, a first read may be obtained from the storage medium based on the MSBs of the L2P LUT and the LSBs from the hash function, where the first read includes a first data entry and a first meta area, and a first conflict check may be performed on the first read based on a first mapping table of the first meta area by comparing the LPN of the read command to an LPN of the first meta area.

According to this embodiment, the LPN of the read command may be the same as the LPN of the first meta area, and the first data entry may be output from the storage medium.

According to this embodiment, the LPN of the read command may be different from the LPN of the first meta area, a second read may be obtained from the storage medium based on the first mapping table, where the second read includes a second data entry, and the second data entry may be output from the storage medium. Alternatively, the LPN of the read command may be different from the LPN of the first meta area, a subsequent read may be obtained from the storage medium, where the subsequent read includes a subsequent data entry and a subsequent meta area, a next conflict check may be performed on the subsequent read based on a subsequent mapping table of the subsequent meta area, the obtaining and performing operations may be repeated in case that the next conflict check fails, and the subsequent data entry may be output from the storage medium in case that the next conflict check passes.

According to this embodiment, the command may be a write command, the generated LSBs may be received at a hash queue as an LSB entry, a plurality of LSB entries may be output from the hash queue at one time, meta data may be generated based on the plurality of LSB entries, the meta data may be combined with corresponding data entries to generate write data, and the write data may be stored at the PPN based on the MSBs and the LSBs, where the hash queue includes random queues.

According to this embodiment, an HOL of each of the random queues may have a valid entry, and entries from the HOL of the random queues may be released. Alternatively, an HOL of one or more of the random queues may have an invalid entry, the hash queue may have fewer entries than capacity, and a next generated LSB may be received at the hash queue as a next LSB entry before outputting the plurality of LSB entries. Alternatively, the HOL of one or more of the random queues may have an invalid entry, the hash queue may be full, valid entries may be released from corresponding random queues, an entry from HOL of a longest queue of the random queues may be selected to release from one of the random queues having the invalid entry.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale. The above and other aspects, features, and advantages of certain embodiments of the present disclosure will be more apparent from the following detailed description, taken in conjunction with the accompanying drawings, in which:

FIG. 1 is a diagram illustrating a data storage management system for processing commands in an electronic device, according to an embodiment;

FIG. 2 is a diagram illustrating an LPN to PPN mapping;

FIG. 3 is a diagram illustrating LPN to PPN mapping with LSB hashing, according to an embodiment;

FIG. 4 is a diagram illustrating read command processing with conflict resolution, according to an embodiment;

FIG. 5 is a flowchart illustrating a method for read command processing with conflict resolution, according to an embodiment;

FIG. 6 is a diagram illustrating a read command processing with conflict resolution, according to another embodiment;

FIG. 7 is a flowchart illustrating a method for read command processing with conflict resolution, according to another embodiment;

FIG. 8 is a diagram illustrating read command processing with conflict resolution, according to another embodiment;

FIG. 9 is a flowchart illustrating a method for read command processing with conflict resolution, according to another embodiment;

FIG. 10 is a diagram illustrating LPN to PPN mapping for a read command, according to an embodiment;

FIG. 11 is a diagram illustrating LPN to PPN mapping for a write command, according to an embodiment;

FIG. 12 is a diagram illustrating a defer conflict bin queue for LSBs of a PPN entry for a write command, according to an embodiment;

FIG. 13 is a flowchart illustrating a method for generating meta areas of a PPN for a write command by deferring conflict resolution, according to embodiment;

FIG. 14 is a diagram illustrating a defer conflict bin queue for LSBs of PPN entry for a write command, according to another embodiment; and

FIG. 15 is a flowchart illustrating a method for generating meta areas of a PPN for a write command with sliding window conflict resolution, according to embodiment;

FIG. 16 is a diagram illustrating LPN to PPN mapping for a write command, according to another embodiment; and

FIG. 17 is a block diagram of an electronic device in a network environment for processing commands, according to an embodiment.

### DETAILED DESCRIPTION

Hereinafter, embodiments of the present disclosure are described in detail with reference to the accompanying drawings. It should be noted that the same elements will be designated by the same reference numerals although they are shown in different drawings. In the following description, specific details such as detailed configurations and components are merely provided to assist with the overall understanding of the embodiments of the present disclosure. Therefore, it should be apparent to those skilled in the art that various changes and modifications of the embodiments described herein may be made without departing from the scope of the present disclosure. In addition, descriptions of well-known functions and constructions are omitted for clarity and conciseness. The terms described below are terms defined in consideration of the functions in the present disclosure, and may be different according to users, intentions of the users, or customs. Therefore, the definitions of the terms should be determined based on the contents throughout this specification.

The present disclosure may have various modifications and various embodiments, among which embodiments are described below in detail with reference to the accompanying drawings. However, it should be understood that the present disclosure is not limited to the embodiments, but includes all modifications, equivalents, and alternatives within the scope of the present disclosure.

Although the terms including an ordinal number such as first, second, etc. may be used for describing various elements, the structural elements are not restricted by the terms. The terms are only used to distinguish one element from another element. For example, without departing from the scope of the present disclosure, a first structural element may be referred to as a second structural element. Similarly, the second structural element may also be referred to as the first structural element. As used herein, the term “and/or” includes any and all combinations of one or more associated items.

The terms used herein are merely used to describe various embodiments of the present disclosure but are not intended to limit the present disclosure. Singular forms are intended to include plural forms unless the context clearly indicates otherwise. In the present disclosure, it should be understood that the terms “include” or “have” indicate existence of a feature, a number, a step, an operation, a structural element, parts, or a combination thereof, and do not exclude the existence or probability of the addition of one or more other features, numerals, steps, operations, structural elements, parts, or combinations thereof.

Unless defined differently, all terms used herein have the same meanings as those understood by a person skilled in the art to which the present disclosure belongs. Terms such as those defined in a generally used dictionary are to be interpreted to have the same meanings as the contextual meanings in the relevant field of art, and are not to be interpreted to have ideal or excessively formal meanings unless clearly defined in the present disclosure.

The terms used in the present disclosure are not intended to limit the present disclosure but are intended to include various changes, equivalents, or replacements for a corresponding embodiment. With regard to the descriptions of the accompanying drawings, similar reference numerals may be used to refer to similar or related elements. A singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, terms such as “1^{st},” “2^{nd},” “first,” and “second” may be used to distinguish a corresponding component from another component, but are not intended to limit the components in other aspects (e.g., importance or order). It is intended that if an element (e.g., a first element) is referred to, with or without the term “operatively” or “communicatively”, as “coupled with,” “coupled to,” “connected with,” or “connected to” another element (e.g., a second element), it indicates that the element may be coupled with the other element directly (e.g., wired), wirelessly, or via a third element.

As used herein, the term “module” may include a unit implemented in hardware, software, firmware, or combination thereof, and may interchangeably be used with other terms, for example, “logic,” “logic block,” “part,” and “circuitry.” A module may be a single integral component, or a minimum unit or part thereof, adapted to perform one or more functions. For example, according to one embodiment, a module may be implemented in a form of an application-specific integrated circuit (ASIC), a co-processor, or field programmable gate arrays (FPGAs).

An electronic device, according to one embodiment, may be one of various types of electronic devices utilizing storage devices (e.g., memory devices). The electronic device may use any suitable storage standard, such as, for example, peripheral component interconnect express (PCIe), nonvolatile memory express (NVMe), NVMe-over-fabric (NVMeoF), advanced extensible interface (AXI), ultra path interconnect (UPI), ethernet, transmission control protocol/Internet protocol (TCP/IP), remote direct memory access (RDMA), RDMA over converged ethernet (ROCE), fibre channel (FC), infiniband (IB), serial advanced technology attachment (SATA), small computer systems interface (SCSI), serial attached SCSI (SAS), Internet wide-area RDMA protocol (iWARP), and/or the like, or any combination thereof. In some embodiments, an interconnect interface may be implemented with one or more memory semantic and/or memory coherent interfaces and/or protocols including one or more compute express link (CXL) protocols such as CXL.mem, CXL.io, and/or CXL.cache, Gen-Z, coherent accelerator processor interface (CAPI), cache coherent interconnect for accelerators (CCIX), and/or the like, or any combination thereof. Any of the memory devices may be implemented with one or more of any type of memory device interface including double data rate (DDR), DDR2, DDR3, DDR4, DDR5, low-power DDR (LPDDRX), open memory interface (OMI), Nvlink high bandwidth memory (HBM), HBM2, HBM3, and/or the like. The electronic devices may include, for example, a portable communication device (e.g., a smart phone), a computer, a portable multimedia device, a portable medical device, a camera, a wearable device, or a home appliance. However, an electronic device is not limited to those described above.

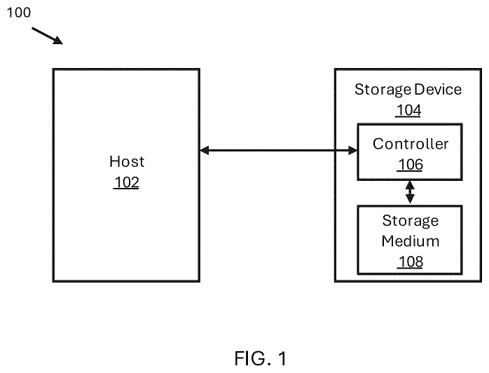

FIG. 1 is a diagram illustrating a data storage management system for processing commands in an electronic device, according to an embodiment. A storage system 100 includes a host 102 and a storage device 104 (e.g., a memory device). Although one host and one storage device are depicted, the storage system 100 may include multiple hosts and/or multiple storage devices. The storage device 104 may be an SSD, a universal flash storage (UFS), etc. The storage device 104 includes a controller 106 and a storage medium 108 connected to the controller 106. The controller 106 may be an SSD controller, a UFS controller, etc. The storage medium 108 may include a volatile memory, a non-volatile memory, or both, and may include one or more flash memory chips (or other storage media). The controller 106 may include one or more processors, one or more error correction circuits, one or more FPGAs, one or more host interfaces, one or more flash bus interfaces, etc., or a combination thereof. The controller 106 may be configured to facilitate transfer of data/commands between the host 102 and the storage medium 108. The host 102 sends data/commands to the storage device 104 to be received by the controller 106 and processed in conjunction with the storage medium 108.

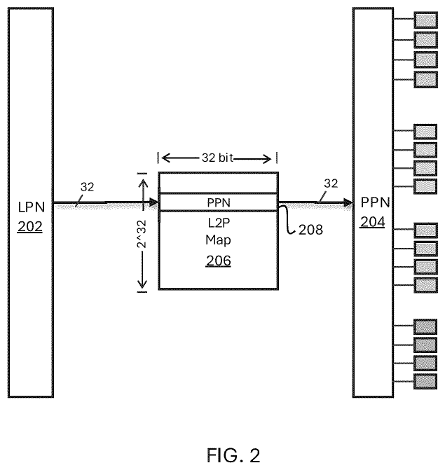

FIG. 2 is a diagram illustrating LPN to PPN mapping. An LPN 202 may be mapped to a PPN 204 via an L2P LUT 206. The L2P LUT 206 includes 2³² individual PPN entries 208 of 32 bits each, resulting in a 16 gigabyte (GB) L2P LUT. However, if drive size increases, the L2P LUT scales up in both entry count and width as shown in Table 1 below.

TABLE 1

| | Drive | Entry | | Table | |
|---|---|---|---|---|---|
| N | Size (TB) | Count | Width | Size (GB) | Ratio |
| 32 | 16 | 2³² | 32 | 16 | 1.00X |
| 33 | 32 | 2³³ | 33 | 34 | 2.06X |
| 34 | 64 | 2³⁴ | 34 | 70 | 4.25X |
| 35 | 128 | 2³⁵ | 35 | 143 | 8.75X |
| 36 | 256 | 2³⁶ | 36 | 295 | 9.00X |

A PPN entry value may expand if not 8 bit aligned. For example, an increase from a 16 terabyte (TB) drive to a 64 TB drive results in a PPN entry count increasing from 2³² to 2³⁴ and an entry width increasing from 32 to 34 bits. The 34 bits is increased to 40 bits for 8 bit alignment, and a resulting table size increases from 16 GB to 80 GB.

In order to maintain linear growth of the L2P LUT, LSBs of a PPN entry in the L2P LUT may be removed so that the incremental growth remains linear. For example, when a drive is increased from 16 TB to 64 TB, an individual PPN entry may be maintained at 32 bits for 8 bit alignment. For a write command, two LSBs of the L2P LUT mapping may be moved from the L2P LUT and placed in a meta area of a data entry of the PPN. For a read command, the two LSBs of the L2P LUT mapping in the meta area may be read along with four data entries, and a data entry indicated by the 2-bit L2P LUT mapping may be output. However, a two-pass L2P LUT (e.g., L2P LUT table and L2P LUT in meta) may incur a significant timing latency. If operating without a second pass L2P LUT in the meta area, all of the second L2P LUTs must be read, which may result in power costs. Specifically, when four additional entries are read, there may be 3-4× more read power consumption.

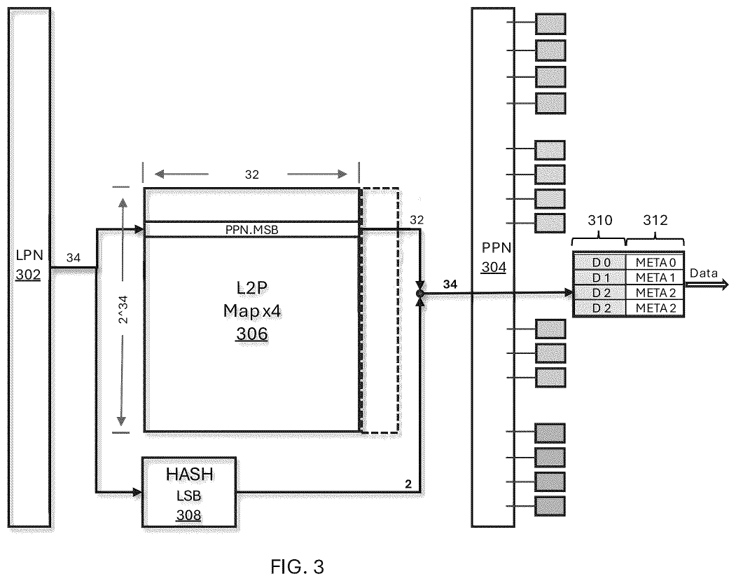

FIG. 3 is a diagram illustrating LPN to PPN mapping with LSB hashing, according to an embodiment. An LPN 302 may be mapped to a PPN 304. An L2P LUT is split into an L2P LUT 306 for MSBs of the PPN entry, and a hash module 308 for LSBs of the PPN entry. Specifically, mapping of the LSBs of the PPN entry is replaced with a hash function. With respect to the example described above regarding an increase from a 16 TB drive to a 64 TB drive, the L2P LUT 306 is used for the 32 MSBs of the PPN entry and the hash function is used for the 2 LSBs of the PPN entry. In performing the hash function, LSBs are locally generated for both write and read commands. Specifically, for a write command a hash function is applied to the 34-bit LPN to determine a write PPN.LSB, and for a read command a hash function is applied to the 34-bit LPN to determine a read PPN.LSB. The LSBs are volatile and not stored. Accordingly, the size of the L2P LUT 306 may be reduced without extra data in a read command, and without extra power required for more than one read. The 32 MSBs of the PPN entry may map to four PPNs in the storage medium having data entries 310 with corresponding meta areas 312. The generated LSBs may be used in combination with the meta areas 312 to determine the mapped PPN 304 and corresponding data entry in the storage medium.

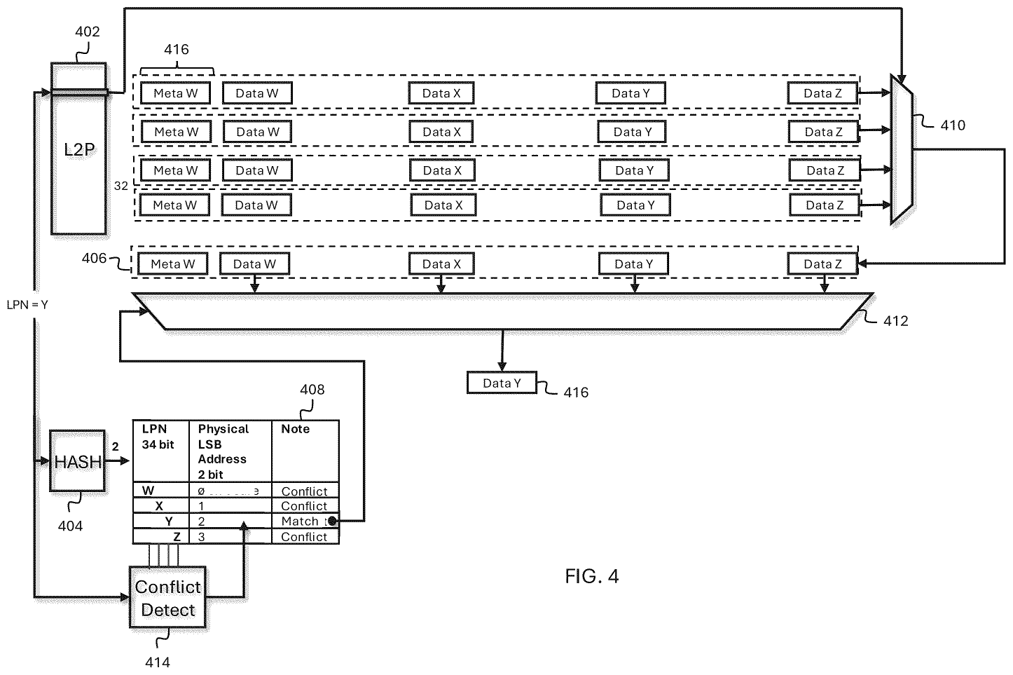

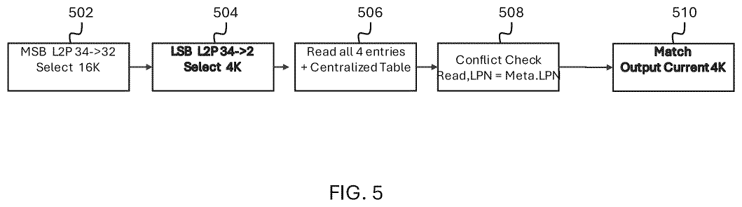

FIG. 4 is a diagram illustrating read command processing with conflict resolution, according to an embodiment. FIG. 5 is a flowchart illustrating a method for read command processing with conflict resolution, according to an embodiment. Generally, conflict resolution information may be written in a meta area, and a conflict may be resolved when data entries are read.

For a given LPN (e.g., Y) of a read command, the LPN may be input to the L2P LUT 402 to obtain MSBs of the PPN entry, at 502. For example, the L2P LUT 402 may provide a 32-bit entry that selects a 16 KB read. At 504, the LPN may be input to a hash module 404 to generate LSBs of the PPN entry. At 506, entries 406 from the storage medium that correspond to the MSBs (e.g., the 16 KB read) and a centralized LSB mapping table 408 from a meta area 416 may be read. Specifically, the MSBs may be provided to a first multiplexer 410 along with entries from the storage medium in order to read out the entries 406 corresponding to the MSBs (e.g., data W, X, Y, Z). These corresponding entries 406 may be provided to a second multiplexer 412 along with the centralized LSB mapping table 408. At 508, a conflict detection module 414 may perform a conflict check to determine which data entry of the entries 406 matches the input LPN (e.g., Y). The centralized mapping table 408 may include a 34-bit LPN column (e.g., input LPN), a 2-bit physical LSB address, and a note indicating match or conflict. At 510, a non-conflicting data entry 418 (e.g., data Y) may be output from the second multiplexer 412 in response to the read command.

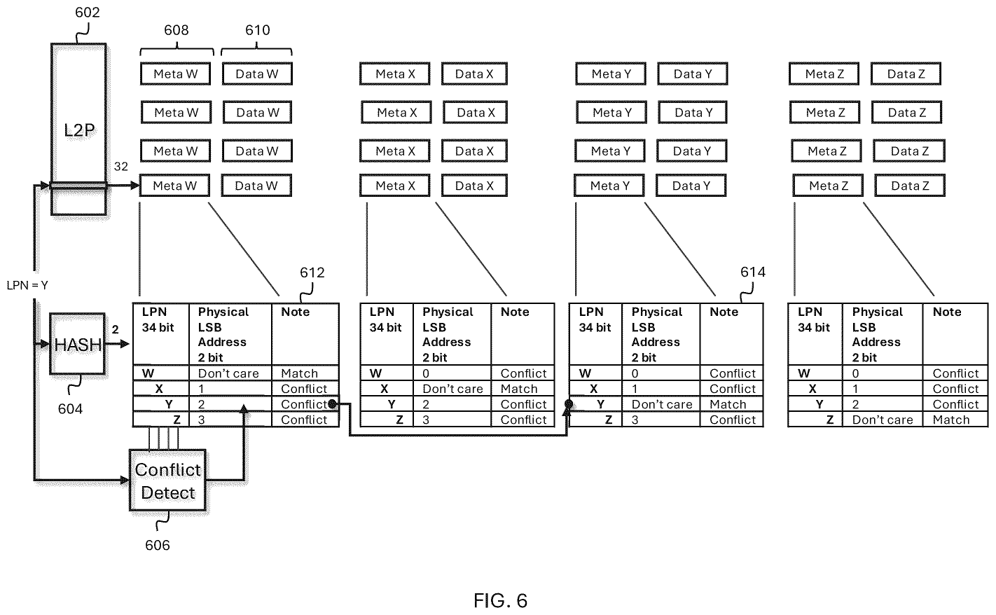

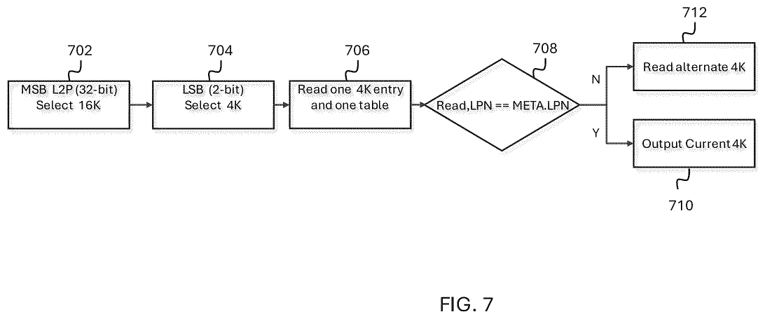

FIG. 6 is a diagram illustrating read command processing with conflict resolution, according to another embodiment. FIG. 7 is a flowchart illustrating a method for read command processing with conflict resolution, according to another embodiment. Generally, if there is a hash conflict, the resolution information may be written in each meta area, and the conflict may be resolved when the data entry is read. For example, if a conflict is detected in a first read, the correct data may be obtained in a subsequent read.

For a given LPN (e.g., Y) of a read command, the LPN may be input to the L2P LUT 602 to obtain MSBs of the PPN entry, at 702. For example, the L2P LUT 602 may provide a 32-bit entry that selects a 16 KB read. At 704, the LPN may be input to a hash module 604 to generate LSBs of the PPN entry. At 706, one 4K data entry 610 and an LSB matching table 612 from a corresponding meta area 608 may be read. At 708, a conflict detection module 606 may perform a conflict check to determine whether the input LPN (e.g., Y) matches a meta LPN via the LSB matching table 612. If the meta LPN matches the read LPN, the current 4K data entry 610 is read out, at 710. If the meta LPN does not match the read LPN, a conflict is detected and an alternate 4K data entry (e.g., Y) is read out as directed by the LSB matching table 612, at 712. The mapping table 612 may include a 34-bit LPN column (e.g., input LPN), a 2-bit physical LSB address, and a note indicating match or conflict. As show in FIG. 6, a conflict is detected between the read LPN (Y) and the meta LPN (W). Based on the 2-bit LSB and the LSB matching table 612, the next read is redirected to the data entry LPN (Y).

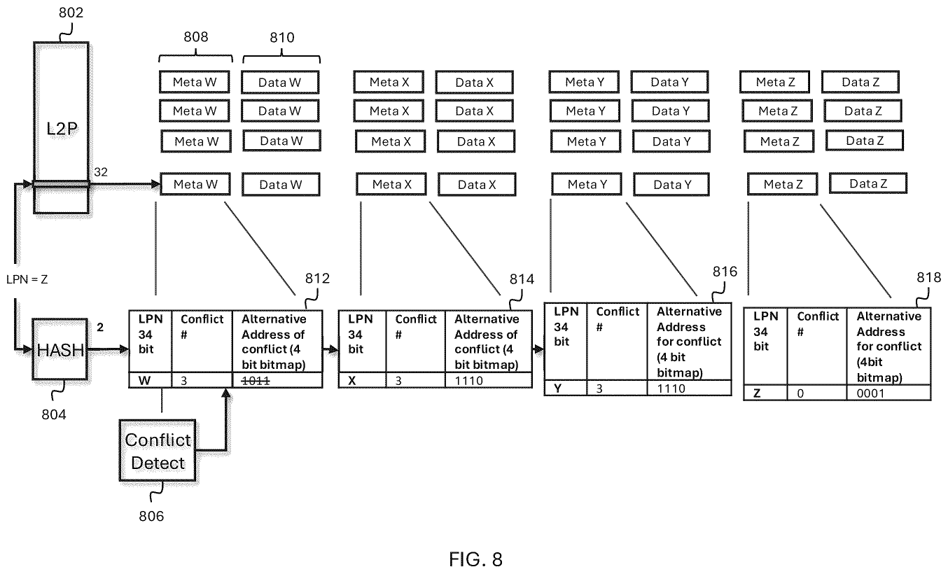

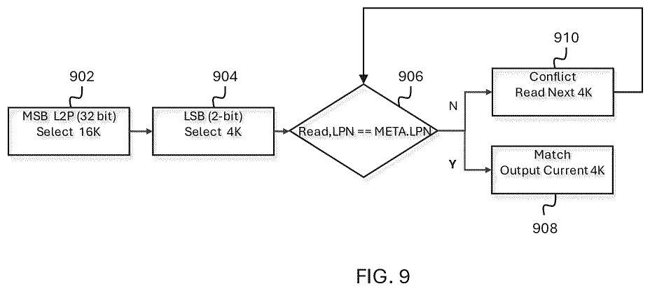

FIG. 8 is a diagram illustrating read command processing with conflict resolution, according to another embodiment. FIG. 9 is a flowchart illustrating a method for read command processing with conflict resolution, according to another embodiment. In order to reduce the size of the meta area in FIG. 6, only conflict entry offsets may be stored in the meta area, and not the LPN of the conflict.

For a given LPN (e.g., Z) of a read command, the LPN may be input to the L2P LUT 802 to obtain MSBs of the PPN entry (16K read), at 902. For example, the L2P LUT 802 may provide a 32-bit entry that selects a 16 KB read. At 904, the LPN may be input to a hash module 804 to generate LSBs of the PPN entry. At 906, a conflict detection module 806 may perform a conflict check to determine whether the input LPN (e.g., Z) matches the meta LPN via the LSB matching table 812 in a meta area 808. If the meta LPN matches the input LPN, a current 4K data entry 810 may be read, at 908. If the meta LPN does not match the input LPN, a conflict is detected and a next 4K data entry is read at 910 before returning to 906 to perform conflict detection. Accordingly, a next 4K data entry is read until the correct 4k data entry is read based on the 2-bit LSB and the LSB matching table 812. The LSB matching table 812 may include a conflict number and an alternative address of conflict (4-bit bitmap). Based on the 2-bit LSB, the next read is redirected to each subsequent data entry LPN (X, Y) having corresponding tables 814, 816, until the correct data (Z) is indicated by a valid bitmap in corresponding table 818, which reduces meta size but increases resolution latency and output.

Instead of reading one entry at a time, the controller may read two or four entries at a time to get the conflict data within 16K. This may reduce resolution latency, but may incur additional power consumption. As another alternative, the meta area may not include offsets or addresses. If there is a conflict, the controller may read all entries to find the correct LPN and data.

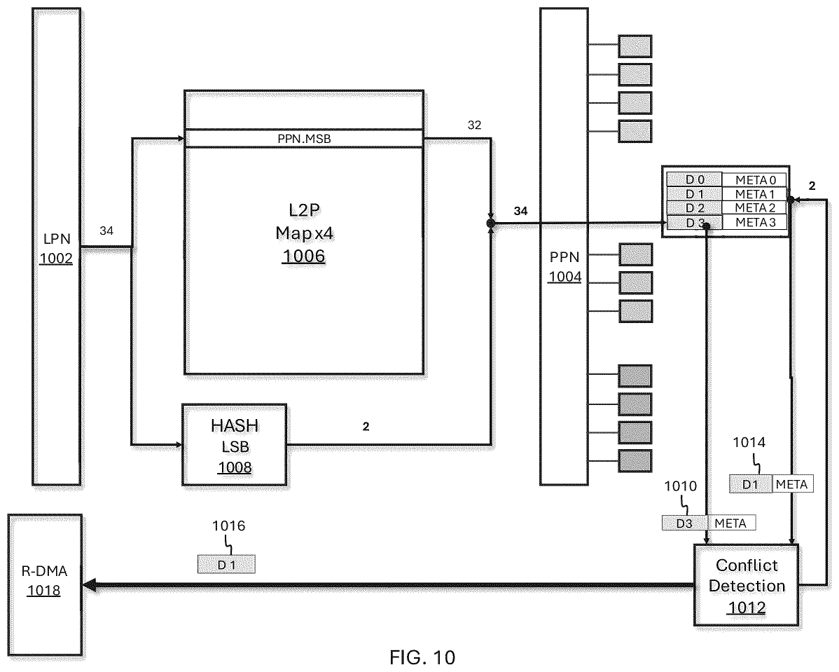

FIG. 10 is a diagram illustrating LPN to PPN mapping for a read command, according to an embodiment. An LPN 1002 corresponding to a read command may be mapped to a PPN 1004. An L2P LUT may be split into an L2P LUT 1006 for MSBs of the PPN entry, and a hash module 1008 for LSBs of the PPN entry. Mapping of the MSBs of the PPN entry may result in a first read 1010 having a data entry and a meta area (as described above with respect to FIGS. 6-9). The first read 1010 may be provided to a conflict detection module 1012. Upon detecting a conflict between the read LPN and the LPN of the meta area at the conflict detection module 1012 based on the LSBs of the PPN entry and the meta area of the first read 1010, a second read 1014 may be performed based on the LSBs of the PPN entry and the meta area, as described above with respect to FIGS. 6-9. The second read 1014, having a data entry and meta area, may be provided to the conflict detection module 1012. If an LPN conflict is not detected, a data entry 1016 of the second read 1014 may be output to remote direct memory access (R-DMA) 1018 based on the read command.

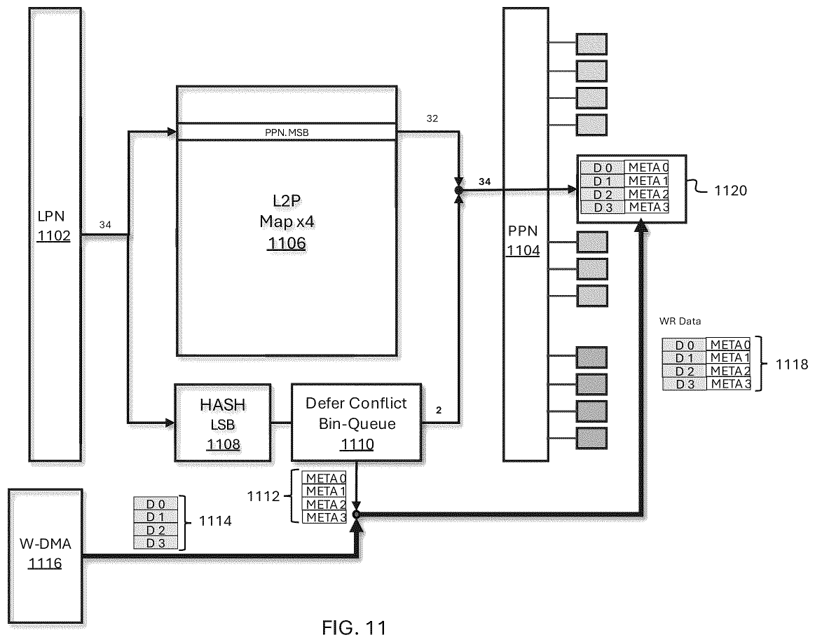

FIG. 11 is a diagram illustrating LPN to PPN mapping for a write command, according to an embodiment. An LPN 1102 of the write command may be mapped to a PPN 1104. An L2P LUT may be split into an L2P LUT 1106 for MSBs of the PPN entry, and a hash module 1108 for LSBs of the PPN entry. For a 64 TB drive, the L2P LUT 306 may be used for the 32 MSBs of the PPN entry and the hash function may be used for the 2 LSBs of the PPN entry. The LSBs from the hash module 1108 may be provided to a defer conflict bin queue 1110, which stores LSB entries and stalls conflicts, by outputting four meta areas 1112 at a time, which correspond to LSBs of four PPN entries. The meta areas 1112 may be combined with respective data entries 1114 from a write direct memory access (W-DMA) 1116 to form write data 1118. The write data 1118 may be written to corresponding mapped PPNs of a storage medium, including the PPN 1104, which is indicated by the combined 32 MSBs of the PPN entry and the 2 LSBs of the PPN entry.

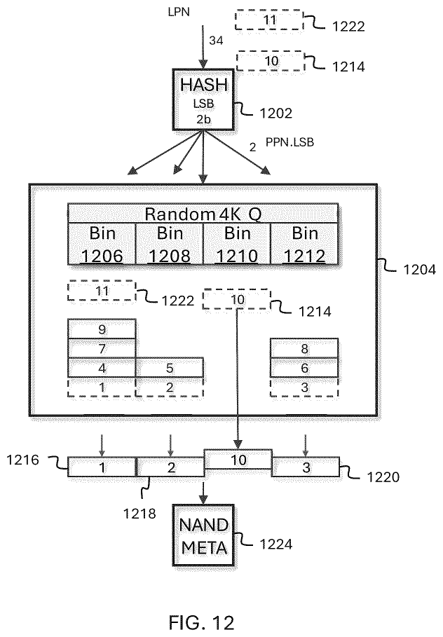

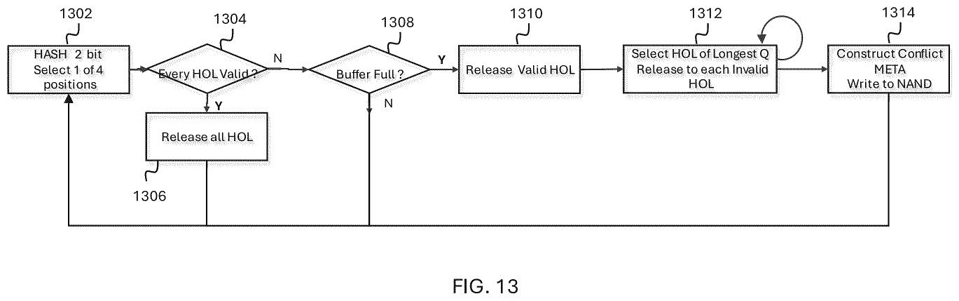

FIG. 12 is a diagram illustrating a defer conflict bin queue for LSBs of a PPN entry for a write command, according to an embodiment. FIG. 13 is a flowchart illustrating a method for generating meta areas by deferring conflict resolution, according to embodiment. A hash module 1202 may assume an even distribution, and transitional conflict may be smoothed out over time (later accesses). Specifically, a conflict may be stored and its resolution may be stalled at a hash queue 1204 (e.g., defer conflict bin queue 1110 of FIG. 11). One LSB entry may be input at a time to the hash queue 1204, and four entries may be released at a time. Conflict resolution may be deferred until an uneven burst dissolves, and conflicts may be resolved when a buffer is full.

At 1302, an LPN may be received at the hash module 1202, and a hash function is performed resulting in an LSB entry (e.g., 2 LSBs of PPN entry). The LSB entry may be provided to the hash queue 1204 and entered into one of a first bin queue 1206, a second bin queue 1208, a third bin queue 1210, and a fourth bin queue 1212. The hash queue 1204 may have a maximum of 16 entries. For example, LSB entry-10 1214 may be entered in the third bin queue 1210. At 1304, it may be determined whether an HOL of each bin queue has a valid entry. If each HOL has a valid entry, all four entries at the HOLs are released at once at 1306, and the methodology returns to 1302 to await a next LSB entry. For example, LSB entry-1 1216 may be released from the first bin queue 1206, LSB entry-2 1218 may be released from the second bin queue 1208, LSB entry-10 1214 may be released from the third bin queue 1210, and LSB entry-3 1220 may be released from the fourth bin queue 1212.

Referring back to 1304, if each HOL does not have a valid entry, it may be determined whether the hash queue 1204 is full, at 1308. If the buffer is not full, the methodology may return to 1302 to await a next LSB entry before releasing HOLs. For example, LSB entry-11 1222 may be stored in the first bin queue 1206. If the hash queue 1204 is full, valid entries at HOLs may be released at 1310, and one or more entries from a bin queues having a longest queue may be selected and released from bin queue HOLs with invalid entries in order to release four entries, at 1312. At 1314, based on the released LSB entries, meta areas 1224 are constructed with conflict information and written to the NAND.

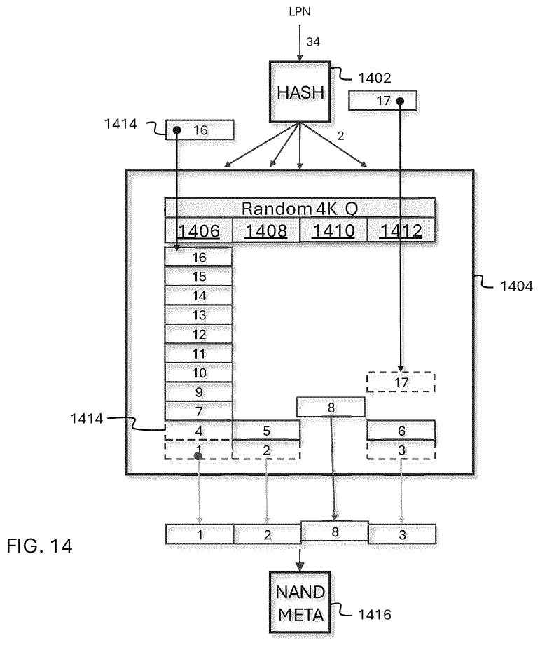

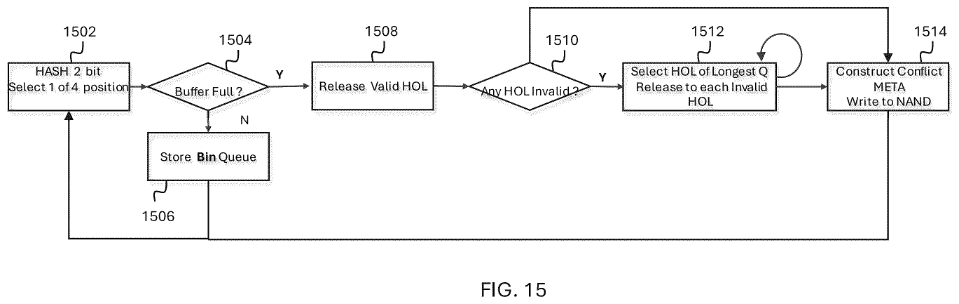

FIG. 14 is a diagram illustrating a defer conflict bin queue for LSBs of PPN entry for a write command, according to another embodiment. FIG. 15 is a flowchart illustrating a method for generating meta areas with sliding window conflict resolution, according to embodiment. Buffers may be filled to a full state, and at a next LPN insertion, four entries at the HOL may be released. An HOL without a valid entry may take a next HOL from a longest bin queue as conflict resolution.

At 1502, an LPN may be received at the hash module 1402, and a hash function may be performed resulting in an LSB entry (e.g., 2 LSBs of a PPN entry). The 2-bit LSB entry may be provided to a hash queue 1404 (e.g., the defer conflict bin queue 1110 of FIG. 11) and entered into one of a first bin queue 1406, a second bin queue 1408, a third bin queue 1410, and a fourth bin queue 1412. The hash queue 1404 may have a maximum of 16 entries. For example, LSB entry-16 1414 may be entered in the first bin queue 1406. At 1504, it may be determined whether the buffer is full. If the buffer is not full, the LSB entry may be stored at 1506 and the methodology returns to 1502 to await a next LSB entry. If the buffer is full, one or more valid entries may be released from one or more queue bin HOLs at 1508. At 1510, it may be determined whether any queue bin HOL has an invalid entry. If there are no invalid entries, meta areas 1016 may be constructed with conflict information and written to the NAND at 1514. If a queue bin HOL has an invalid entry, an HOL entry from a longest queue may be selected and released from the queue bin HOL with an invalid entry at 1512. For example, LSB entry-4 1416 may be released from a HOL of the third bin queue 1410 when the third bin queue 1410 is empty. At 1514, based on the released LSB entries, meta areas 1016 may be constructed with conflict information and written to the NAND, and the methodology returns to 1502 to await a next LSB entry.

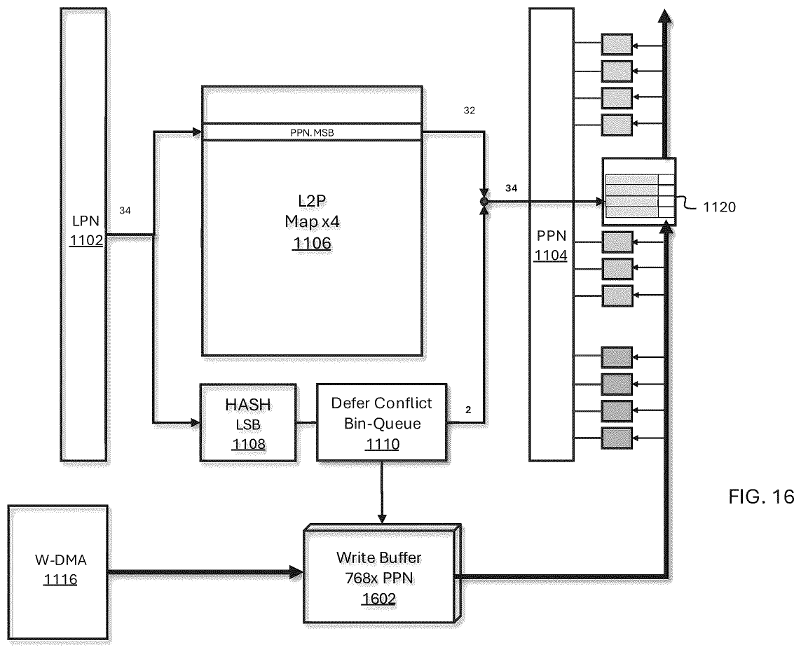

FIG. 16 is a diagram illustrating LPN to PPN mapping for a write command, according to another embodiment. The embodiment described above with respect to FIG. 15 may be modified with the addition of a write buffer 1602. Latency impact to a NAND storage system may be reduced by the write buffer 1602 used in a NAND stripe-write methodology. Non-overlap entries in a 4-entry chunk may immediately be released to the write buffer 1602. Overlapped entries may be stored in a single conflict queue. The conflict queue may not drain until a new overlap arrives and the conflict queue is full.

If a drive scaled up from 34 to 36 (e.g., 64 TB to 256 TB), item sizes may be changed as set forth in Table 2 below.

TABLE 2

| # | Item | Change |
|---|---|---|
| 1 | LPN Size | LPN width: 34 -> 36 bit |
| | | Drive Size: 64 T -> 256 T |
| 2 | MSB L2P | Index Key: 2\hat{ }34 -> 2\hat{ }36 |
| | | Entry Value: 32 -> 32 (not changed) |
| 3 | LSB HASH | Input: 34 -> 36 bit |
| | | Output: 2 -> 4 bit (changed) |
| 4 | Defer Queue Bin | Queue #: 4 -> 16 (changed) |
| 5 | Defer Queue Pool | Max Buffer: 64 -> 64 |
| 6 | Conflict | Offset bitmap: 4 -> 16 (changed) |
| | Resolution offset | |

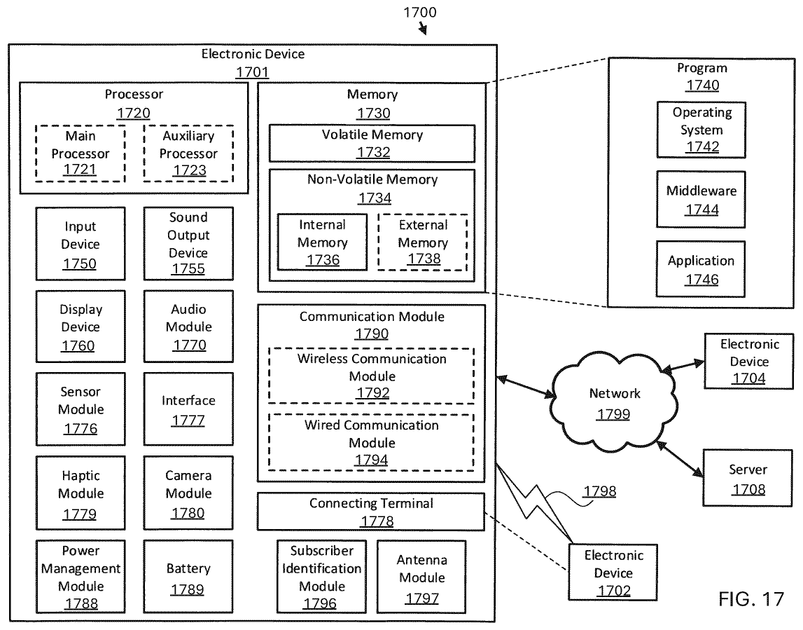

FIG. 17 is a block diagram of an electronic device in a network environment 1700 for processing commands, according to an embodiment. This electronic device may be one of various types of electronic devices that utilizes storage devices described above in FIGS. 1 and 16.

Referring to FIG. 17, an electronic device 1701 in a network environment 1700 may communicate with an electronic device 1702 via a first network 1798 (e.g., a short-range wireless communication network), or an electronic device 1704 or a server 1708 via a second network 1799 (e.g., a long-range wireless communication network). The electronic device 1701 may communicate with the electronic device 1704 via the server 1708. The electronic device 1701 may include a processor 1720, a memory 1730, an input device 1750, a sound output device 1755, a display device 1760, an audio module 1770, a sensor module 1776, an interface 1777, a haptic module 1779, a camera module 1780, a power management module 1788, a battery 1789, a communication module 1790, a subscriber identification module (SIM) card 1796, or an antenna module 1797. In one embodiment, at least one (e.g., the display device 1760 or the camera module 1780) of the components may be omitted from the electronic device 1701, or one or more other components may be added to the electronic device 1701. Some of the components may be implemented as a single integrated circuit (IC). For example, the sensor module 1776 (e.g., a fingerprint sensor, an iris sensor, or an illuminance sensor) may be embedded in the display device 1760 (e.g., a display).

The processor 1720 may execute software (e.g., a program 1740) to control at least one other component (e.g., a hardware or a software component) of the electronic device 1701 coupled with the processor 1720 and may perform various data processing or computations.

As at least part of the data processing or computations, the processor 1720 may load a command or data received from a host or another component (e.g., the sensor module 1776 or the communication module 1790) in volatile memory 1732, process the command or the data stored in the volatile memory 1732, and store resulting data in non-volatile memory 1734. The processor 1720 may include a main processor 1721 (e.g., a central processing unit (CPU) or an application processor (AP)), and an auxiliary processor 1723 (e.g., a graphics processing unit (GPU), an image signal processor (ISP), a sensor hub processor, or a communication processor (CP)) that is operable independently from, or in conjunction with, the main processor 1721. Additionally or alternatively, the auxiliary processor 1723 may be adapted to consume less power than the main processor 1721, or execute a particular function. The auxiliary processor 1723 may be implemented as being separate from, or a part of, the main processor 1721.

The auxiliary processor 1723 may control at least some of the functions or states related to at least one component (e.g., the display device 1760, the sensor module 1776, or the communication module 1790) among the components of the electronic device 1701, instead of the main processor 1721 while the main processor 1721 is in an inactive (e.g., sleep) state, or together with the main processor 1721 while the main processor 1721 is in an active state (e.g., executing an application). The auxiliary processor 1723 (e.g., an image signal processor or a communication processor) may be implemented as part of another component (e.g., the camera module 1780 or the communication module 1790) functionally related to the auxiliary processor 1723.

The memory 1730 may store various data used by at least one component (e.g., the processor 1720 or the sensor module 1776) of the electronic device 1701. The various data may include, for example, software (e.g., the program 1740) and input data or output data for a command related thereto. The memory 1730 may include the volatile memory 1732 or the non-volatile memory 1734. Non-volatile memory 1734 may include internal memory 1736 and/or external memory 1738. The memory 1730 may be embodied as the storage device 104 of FIG. 1.

The program 1740 may be stored in the memory 1730 as software, and may include, for example, an operating system (OS) 1742, middleware 1744, or an application 1746.

The input device 1750 may receive a command or data to be used by another component (e.g., the processor 1720) of the electronic device 1701, from the outside (e.g., a user) of the electronic device 1701. The input device 1750 may include, for example, a microphone, a mouse, or a keyboard.

The sound output device 1755 may output sound signals to the outside of the electronic device 1701. The sound output device 1755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1760 may visually provide information to the outside (e.g., a user) of the electronic device 1701. The display device 1760 may include, for example, a display, a hologram device, or a projector and control circuitry to control a corresponding one of the display, hologram device, and projector. The display device 1760 may include touch circuitry adapted to detect a touch, or sensor circuitry (e.g., a pressure sensor) adapted to measure the intensity of force incurred by the touch.

The audio module 1770 may convert a sound into an electrical signal and vice versa. The audio module 1770 may obtain the sound via the input device 1750 or output the sound via the sound output device 1755 or a headphone of an external electronic device 1702 directly (e.g., wired) or wirelessly coupled with the electronic device 1701.

The sensor module 1776 may detect an operational state (e.g., power or temperature) of the electronic device 1701 or an environmental state (e.g., a state of a user) external to the electronic device 1701, and then generate an electrical signal or data value corresponding to the detected state. The sensor module 1776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1777 may support one or more specified protocols to be used for the electronic device 1701 to be coupled with the external electronic device 1702 directly (e.g., wired) or wirelessly. The interface 1777 may include, for example, a high-definition multimedia interface (HDMI), a universal serial bus (USB) interface, a secure digital (SD) card interface, or an audio interface.

A connecting terminal 1778 may include a connector via which the electronic device 1701 may be physically connected with the external electronic device 1702. The connecting terminal 1778 may include, for example, an HDMI connector, a USB connector, an SD card connector, or an audio connector (e.g., a headphone connector).

The haptic module 1779 may convert an electrical signal into a mechanical stimulus (e.g., a vibration or a movement) or an electrical stimulus which may be recognized by a user via tactile sensation or kinesthetic sensation. The haptic module 1779 may include, for example, a motor, a piezoelectric element, or an electrical stimulator.

The camera module 1780 may capture a still image or moving images. The camera module 1780 may include one or more lenses, image sensors, image signal processors, or flashes. The power management module 1788 may manage power supplied to the electronic device 1701. The power management module 1788 may be implemented as at least part of, for example, a power management integrated circuit (PMIC).

The battery 1789 may supply power to at least one component of the electronic device 1701. The battery 1789 may include, for example, a primary cell which is not rechargeable, a secondary cell which is rechargeable, or a fuel cell.

The communication module 1790 may support establishing a direct (e.g., wired) communication channel or a wireless communication channel between the electronic device 1701 and the external electronic device (e.g., the electronic device 1702, the electronic device 1704, or the server 1708) and performing communication via the established communication channel. The communication module 1790 may include one or more communication processors that are operable independently from the processor 1720 (e.g., the AP) and supports a direct (e.g., wired) communication or a wireless communication. The communication module 1790 may include a wireless communication module 1792 (e.g., a cellular communication module, a short-range wireless communication module, or a global navigation satellite system (GNSS) communication module) or a wired communication module 1794 (e.g., a local area network (LAN) communication module or a power line communication (PLC) module). A corresponding one of these communication modules may communicate with the external electronic device via the first network 1798 (e.g., a short-range communication network, such as BLUETOOTH™, wireless-fidelity (Wi-Fi) direct, or a standard of the Infrared Data Association (IrDA)) or the second network 1799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1792 may identify and authenticate the electronic device 1701 in a communication network, such as the first network 1798 or the second network 1799, using subscriber information (e.g., international mobile subscriber identity (IMSI)) stored in the subscriber identification module 1796.

The antenna module 1797 may transmit or receive a signal or power to or from the outside (e.g., the external electronic device) of the electronic device 1701. The antenna module 1797 may include one or more antennas, and, therefrom, at least one antenna appropriate for a communication scheme used in the communication network, such as the first network 1798 or the second network 1799, may be selected, for example, by the communication module 1790 (e.g., the wireless communication module 1792). The signal or the power may then be transmitted or received between the communication module 1790 and the external electronic device via the selected at least one antenna.

Commands or data may be transmitted or received between the electronic device 1701 and the external electronic device 1704 via the server 1708 coupled with the second network 1799. Each of the electronic devices 1702 and 1704 may be a device of a same type as, or a different type, from the electronic device 1701. All or some of operations to be executed at the electronic device 1701 may be executed at one or more of the external electronic devices 1702, 1704, or 1708. For example, if the electronic device 1701 should perform a function or a service automatically, or in response to a request from a user or another device, the electronic device 1701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1701. The electronic device 1701 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

What is claimed is:

1. A method comprising:
receiving, by a controller of a storage device, a command with a corresponding logical page number (LPN);
mapping, by the controller, the LPN to a physical page number (PPN) in a storage medium of the storage device based on a logical-to-physical (L2P) look-up table (LUT) comprising most significant bits (MSBs) of a PPN entry;
generating, by the controller, least significant bits (LSBs) of the PPN entry from the LPN based on a hash function; and
determining, by the controller, the PPN for the command based on the MSBs, the LSBs, and a meta area in the storage medium.

2. The method of claim 1, wherein the command is a read command and determining the PPN comprises:
obtaining data entries from the storage medium based on the MSBs of the L2P LUT;
performing a conflict check on the data entries based on a centralized mapping table in the meta area of the storage medium; and
outputting a data entry from the data entries that passes the conflict check.

3. The method of claim 1, wherein the command is a read command and determining the PPN comprises:
obtaining a first read from the storage medium based on the MSBs of the L2P LUT and the LSBs from the hash function, wherein the first read comprises a first data entry and a first meta area; and
performing a first conflict check on the first read based on a first mapping table of the first meta area.

4. The method of claim 3, wherein performing the first conflict check comprises:
comparing the LPN of the read command to an LPN of the first meta area.

5. The method of claim 4, wherein the LPN of the read command is the same as the LPN of the first meta area, and further comprising:
outputting the first data entry from the storage medium.

6. The method of claim 4, wherein:
the LPN of the read command is different from the LPN of the first meta area; and
determining the PPN further comprises:
obtaining a second read from the storage medium based on the first mapping table, wherein the second read comprises a second data entry; and
outputting the second data entry from the storage medium.

7. The method of claim 4, wherein:
the LPN of the read command is different from the LPN of the first meta area; and
determining the PPN further comprises:
obtaining a subsequent read from the storage medium, wherein the subsequent read comprises a subsequent data entry and a subsequent meta area;
performing a next conflict check on the subsequent read based on a subsequent mapping table of the subsequent meta area;
repeating the obtaining and performing steps in case that the next conflict check fails; and
outputting the subsequent data entry from the storage medium in case that the next conflict check passes.

8. The method of claim 1, wherein the command is a write command and further comprising:
receiving the generated LSBs at a hash queue as an LSB entry;
outputting a plurality of LSB entries from the hash queue at one time;
generating meta data based on the plurality of LSB entries;
combining the meta data with corresponding data entries to generate write data; and
storing the write data at the PPN based on the MSBs and the LSBs.

9. The method of claim 8, wherein the hash queue comprises random queues that each output one of the plurality of LSB entries.

10. The method of claim 9, wherein a head-of-line (HOL) of each of the random queues has a valid entry, and outputting the plurality of LSB entries comprises:
releasing entries from the HOL of the random queues.

11. The method of claim 9, wherein an HOL of one or more of the random queues has an invalid entry, the hash queue has fewer entries than capacity, and further comprising:
receiving next generated LSBs at the hash queue as a next LSB entry before outputting the plurality of LSB entries.

12. The method of claim 9, wherein an HOL of one or more of the random queues has an invalid entry, the hash queue is full, and outputting the plurality of LSB entries comprises:
releasing valid entries from HOL of corresponding random queues;
selecting an entry from HOL of a longest queue of the random queues to release from the one of the random queues having the invalid entry; and
releasing the selected entry with the valid entries.

13. A storage device comprising:
a controller; and
a non-transitory computer readable storage medium storing instructions that, when executed, cause the controller to:
receive a command with a corresponding logical page number (LPN);
map the LPN to a physical page number (PPN) in the storage medium based on a logical-to-physical (L2P) look-up table (LUT) comprising most significant bits (MSBs) of a PPN entry;
generate least significant bits (LSBs) of the PPN entry from the LPN based on a hash function; and
determine the PPN for the command based on the MSBs, the LSBs, and a meta area in the storage medium.

14. The storage device of claim 13, wherein the command is a read command and, in determining the PPN, the instructions further cause the controller to:
obtain data entries from the storage medium based on the MSBs of the L2P LUT;
perform a conflict check on the data entries based on a centralized mapping table in the meta area of the storage medium; and
output a data entry from the data entries that passes the conflict check.

15. The storage device of claim 13, wherein the command is a read command and, in determining the PPN, the instructions further cause the controller to:
obtain a first read from the storage medium based on the MSBs of the L2P LUT and the LSBs from the hash function, wherein the first read comprises a first data entry and a first meta area; and
perform a first conflict check on the first read based on a first mapping table of the first meta area by comparing the LPN of the read command to an LPN of the first meta area.

16. The storage device claim 15, wherein the LPN of the read command is the same as the LPN of the first meta area, and the instructions further cause the controller to:
output the first data entry from the storage medium.

17. The storage device of claim 15, wherein:
the LPN of the read command is different from the LPN of the first meta area; and
in determining the PPN, the instructions further cause the controller to:
obtain a second read from the storage medium based on the first mapping table, wherein the second read comprises a second data entry; and
outputting the second data entry from the storage medium.

18. The storage device of claim 15, wherein:
the LPN of the read command is different from the LPN of the first meta area; and
in determining the PPN, the instructions further cause the controller to:
obtain a subsequent read from the storage medium, wherein the subsequent read comprises a subsequent data entry and a subsequent meta area;
perform a next conflict check on the subsequent read based on a subsequent mapping table of the subsequent meta area;
repeat the obtaining and performing operations in case that the next conflict check fails; and
output the subsequent data entry from the storage medium in case that the next conflict check passes.

19. The storage device of claim 13, wherein the command is a write command and the instructions further cause the controller to:
receive the generated LSBs at a hash queue as an LSB entry;
output a plurality of LSB entries from the hash queue at one time;
generate meta data based on the plurality of LSB entries;
combine the meta data with corresponding data entries to generate write data; and
store the write data at the PPN based on the MSBs and the LSBs,
wherein the hash queue comprises random queues.

20. The storage device of claim 19, wherein:
a head-of-line (HOL) of each of the random queues has a valid entry, and entries from the HOL of the random queues are released; or
an HOL of one or more of the random queues has an invalid entry, the hash queue has fewer entries than capacity, and next generated LSBs are received at the hash queue as a next LSB entry before outputting the plurality of LSB entries; or
the HOL of one or more of the random queues has the invalid entry, the hash queue is full, valid entries are released from HOL of corresponding random queues, an entry from HOL of a longest queue of the random queues is selected to release from the one of the random queues having the invalid entry.
